(19) United States
(12) Patent Application Publication
(10) Pub. No.: US 2014/0306366 A1
(43) Pub. Date: Oct. 16, 2014

(54) MOLDING DIE AND MOLDING METHOD

(71) Applicant: SUZUKI MOTOR CORPORTION, Hamamatsu-shi, Shizuoka-ken (JP)

(72) Inventor: Takahisa Egawa, Shizuoka-ken (JP)

(21) Appl. No.: 14/359,046

(22) PCT Filed: Nov. 22, 2012
(86) PCT No.: PCT/JP2012/080267

§ 371 Date: May 16, 2014

(30) Foreign Application Priority Data
Nov. 24, 2011 (JP) 2011-256184

(51) Int. Cl. B29C 44/58; B29C 44/42

(52) U.S. Cl. CPC B29C 44/588; B29C 44/42
USPC 264/41; 425/4 R

(57) ABSTRACT

A molding die for molding a foam molding in a cavity constituted in the interior by matching a stationary die and a movable die, the cavity being able to be filled with molten resin, and the foam molding being produced using counter-pressure. A seal material for sealing the pressurization area for the counter pressure technique between the stationary die and the movable die is provided to the molding die, and the seal material is constituted of an elastic foam that has open cells.

### PRIORITY CLAIM

This patent application is a U.S. National Phase of International Patent Application No. PCT/JP2012/080267, filed 22 Nov. 2012, which claims priority to Japanese Patent Application No. 2011-256184, filed 24 Nov. 2011, the disclosures of which are incorporated herein by reference in their entirety.

### TECHNICAL FIELD

The present invention relates to a forming mold and a molding method which prevent an appearance defect in foam molding to thereby improve an appearance shape of a foam-molded product.

### BACKGROUND ART

In recent years, to reduce CO2 emitted from automobiles, there is a demand for an improvement in fuel economy. It is therefore essential to reduce automobile weights. Because of this reason, although a method for reducing weights by decreasing a part thickness of an automobile interior resin part is proposed, when a product thickness is decreased, it becomes difficult to ensure rigidity of the product.

On the other hand, there is also provided an injection foam molding using a forming mold as a method for ensuring the rigidity of the product while reducing weight of the product. The injection foam molding is a method in which a foaming agent is added to PP resin, the molten resin is injected into a molding space (i.e., cavity) of the forming mold, and a movable mold half of the mold is moved by a prescribed distance (core-back) to effect the foaming process.

In the injection foam molding, when a molten resin is injected into a cavity of a forming mold and a pressure is decreased, the foaming process is started. When foamed cells in the molten resin flow within the forming mold while being defoamed, a silver-white streak (referred to as swirl mark hereinafter) occurs, and when the molten resin flowing in the mold catches defoamed air, a depression (dent, so-called “crater”) occurs in a product surface.

To respond to the problem of the swirl mark and the depression, a counter-pressure method for suppressing the swirl mark and the depression by injecting the molten resin into the mold cavity after injecting air into the cavity in advance to increase a pressure inside the mold to a foaming pressure or more has been known (Patent Document 1).

### PRIOR ART DOCUMENT

### Patent Document

Patent Document 1: Japanese Patent Laid-Open Publication No. 2010-115857

### SUMMARY OF THE INVENTION

### Problems to be Solved by the Invention

In the mold for injection foam molding using the counter-pressure method, since the pressurized air is injected into the cavity, the injected air remains as residual air without being discharged outside of the mold. Such residual air may inhibit the foaming, or the molten resin may catch the residual air which generates the depression when the molten resin is fed into the cavity and then molded therein.

Moreover, when the forming mold using the counter-pressure method is employed, a suction method using a vacuum pump or the like is employed as a method for efficiently discharging the injected air outside of the mold after injecting the air.

However, it is difficult to discharge the injected air outside of the mold at a right timing. If the air is discharged too early, the pressure inside the mold is lowered, and the appearance defect such as the swirl mark and the depression disadvantageously occurs. If the air is discharged too late, the foaming is inhibited by the residual air in the mold, and the depression or the foaming defect disadvantageously occurs. It is thus necessary to further introduce a vacuum drawing equipment or like.

The present invention has been made in consideration of the above circumstances, and an object thereof is to provide a forming mold and a molding method which can effectively prevent a swirl mark or a depression (a crater) that is an appearance defect peculiar to foam molding to thereby improve an appearance shape of a foam-molded product.

### Means for Solving the Problems

A forming mold provided for achieving the above object is a forming mold configured to manufacture a foam-molded product, by molding, in use of a counter-pressure method, the foal-molded product that is obtained by feeding molten resin into a cavity formed within a fixed mold and a movable mold mated together,

wherein a seal material that seals pressurized air used in the counter-pressure method between the fixed mold and the movable mold is composed of an elastic foam material having interconnected cells.

A molding method is also provided for achieving the above object. That is, the molding method for molding a foam-molded product obtained by feeding molten resin into a cavity formed within a fixed mold and a movable mold mated together includes the steps of:

forming a cavity to be filled with molten resin in a forming mold with a fixed mold and a movable mold;

sealing the cavity with interconnected cells of a seal material collapsed when the forming mold is closed;

discharging residual air that prevents foaming of the molten resin outside of the forming mold due to a property of the interconnected cells of the seal material having an elastic restoring force when the forming mold is opened; and

producing a foam-molded product from the molten resin in the forming mold.

In the above embodiment of the present invention, it may be desired that the seal material is provided on a mating surface of at least one of the fixed mold and the movable mold in a manner of a closed loop surrounding the cavity.

In addition, it may be also desired that the interconnected cells of the seal material are restored by an elastic restoring force in a core-back operation in which the movable mold is retracted from the fixed mold.

### Effects of the Invention

In the present invention, the elastic foam (elastic foam material) having the interconnected cells is used as the seal material. Thus, when the air is injected after clamping the forming mold, the interconnected cells of the seal material collapse to fulfill a sealing function. When the mold is opened in the core-back operation, the interconnected cells of the seal material are restored to discharge the residual air outside of the mold without blocking the foaming action, and a foam-molded product with no swirl mark or depression can be obtained. In addition, the product can provide an improved appearance shape and condition, thus being advantageous.

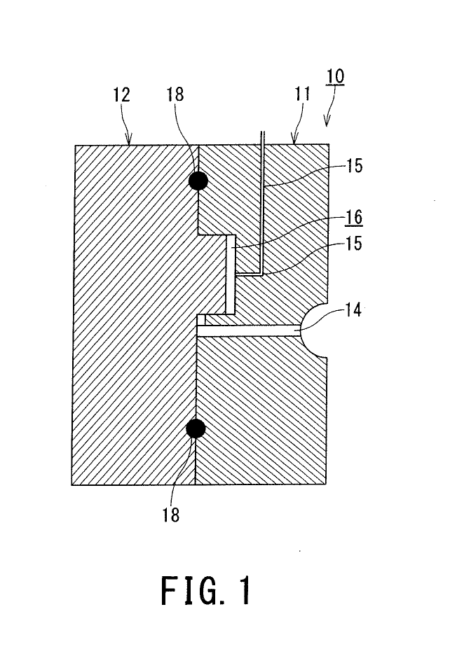

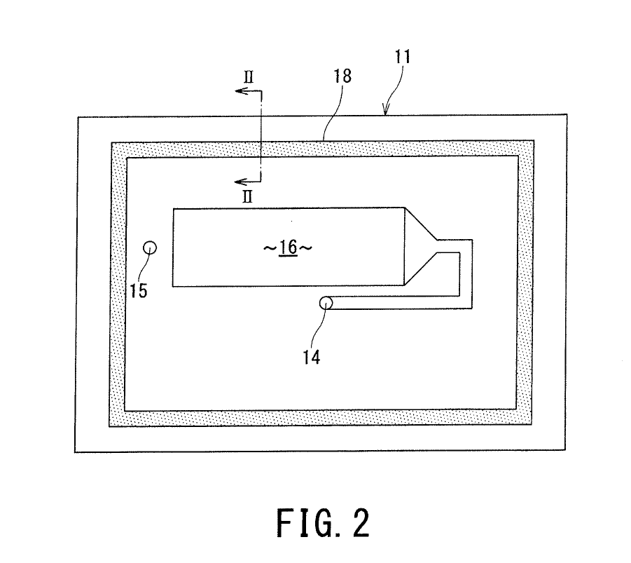

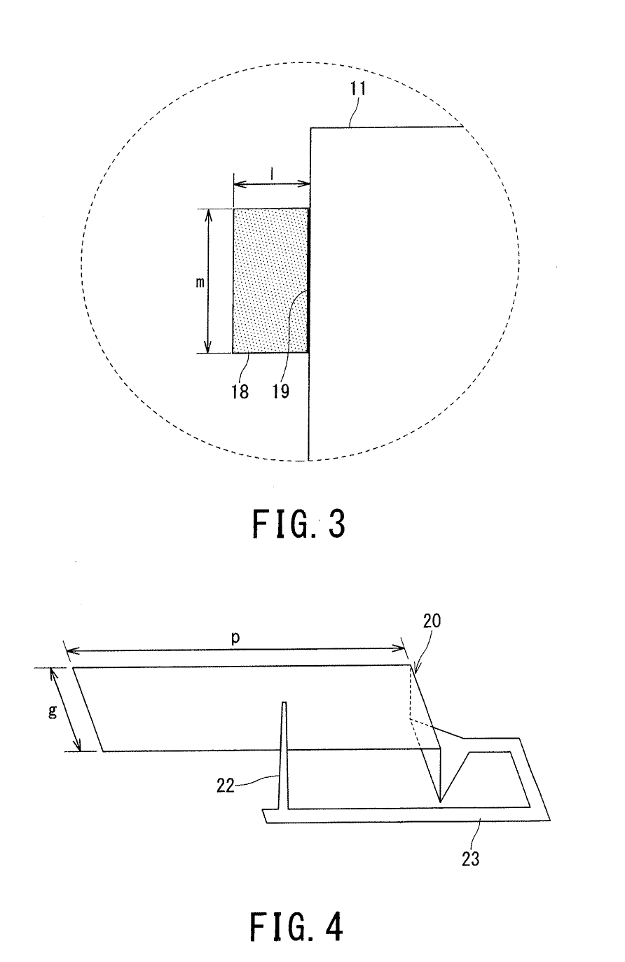

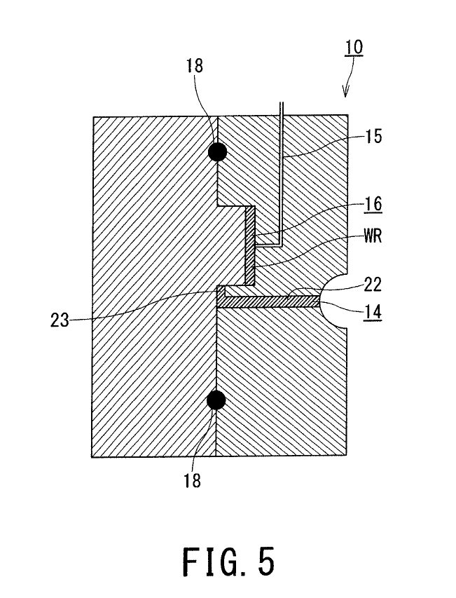

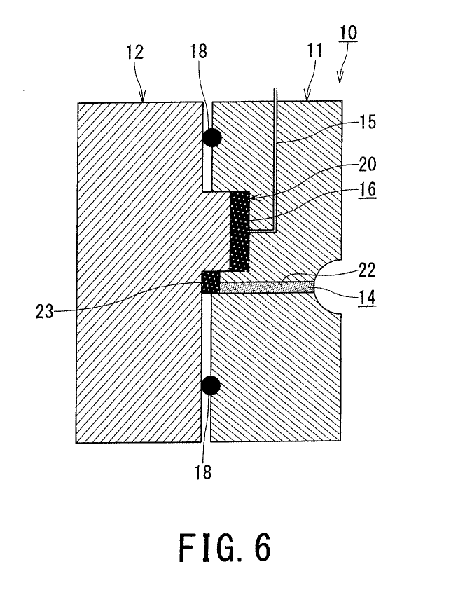

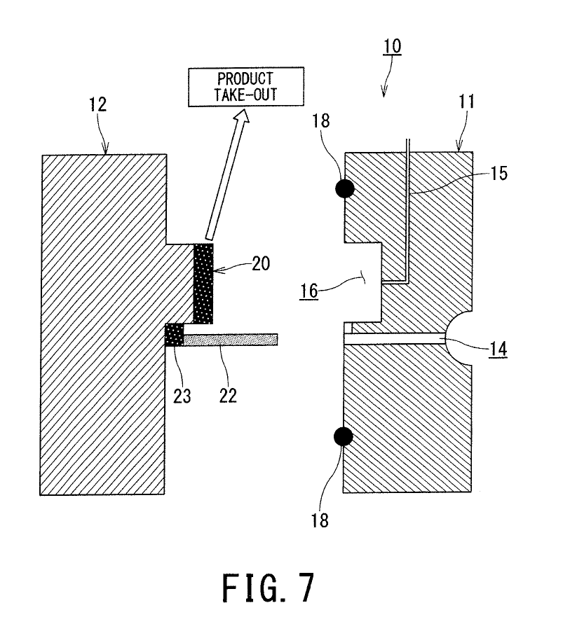

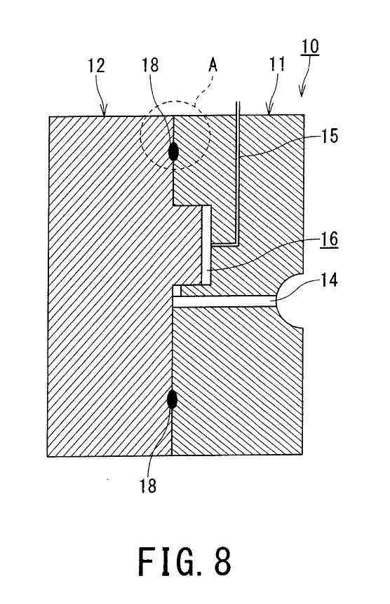

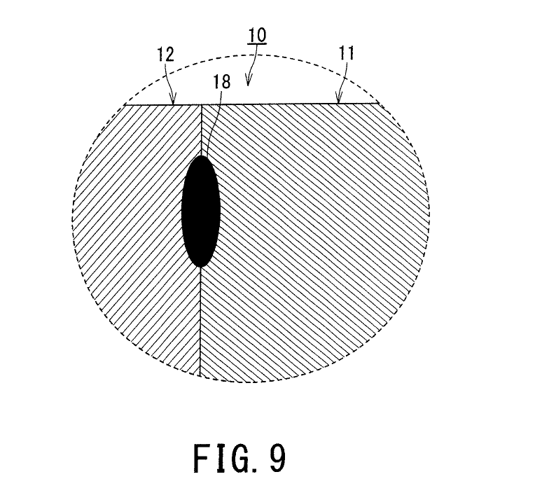

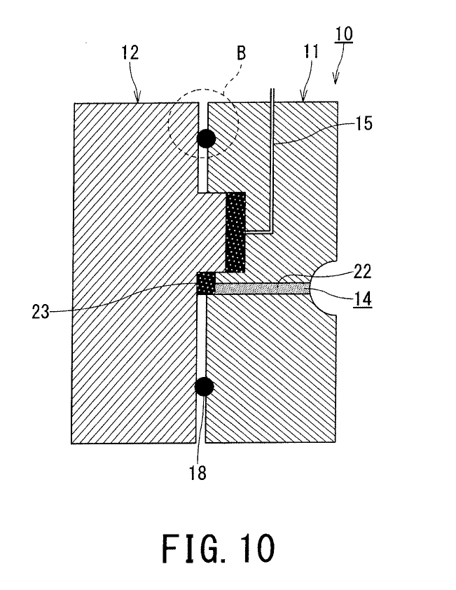

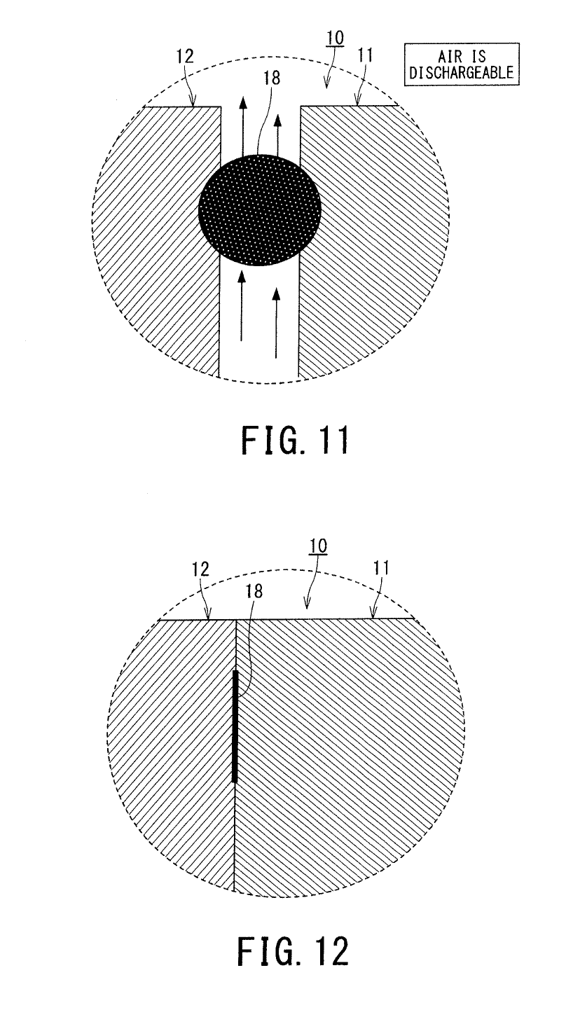

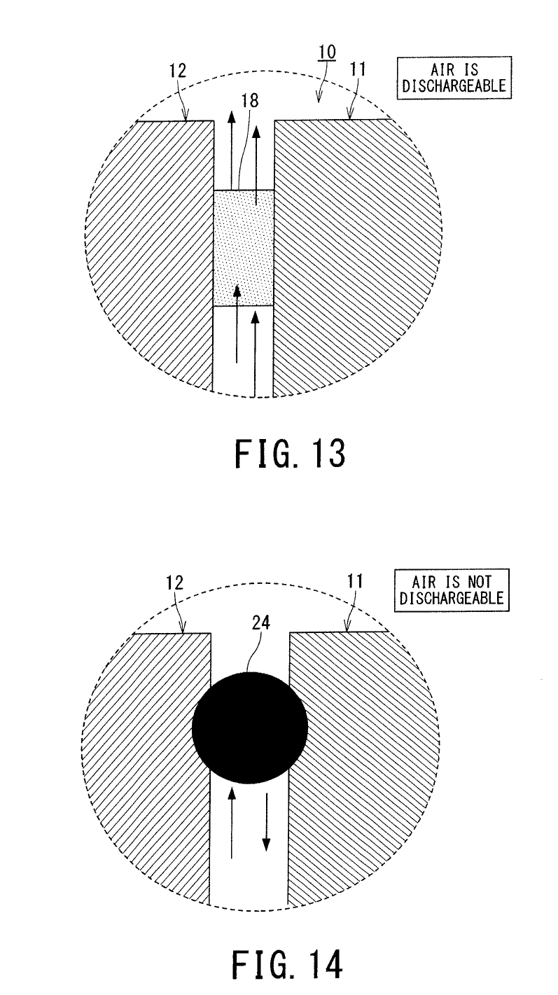

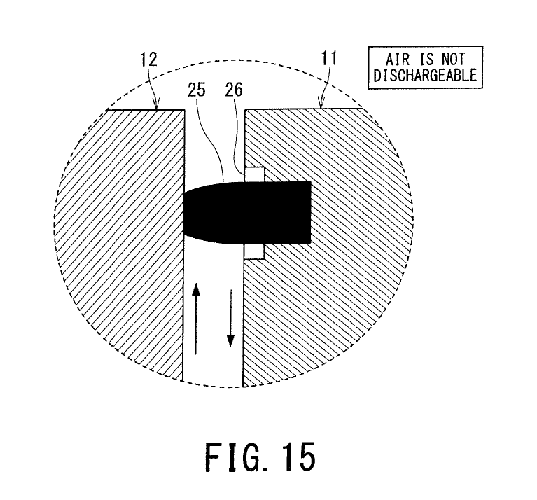

### BRIEF DESCRIPTION OF THE DRAWINGS

[FIG. 1] is a schematic sectional view of a forming mold before injecting resin according to an embodiment of the present invention.

[FIG. 2] is a view illustrating a state of a movable mold of the forming mold before injecting the resin.

[FIG. 3] is a sectional view taken along the line II-II in FIG. 2 illustrating an attachment state of a seal material attached to a fixed mold (or the movable mold half).

[FIG. 4] is a view illustrating a product shape example of a foam-molded product produced by the forming mold.

[FIG. 5] is a schematic sectional view illustrating the forming mold after injecting the resin and before a core-back operation.

[FIG. 6] is a schematic sectional view illustrating the forming mold after the core-back operation.

[FIG. 7] is a sectional view illustrating a state at a product removal time in which the foam-molded article is removed from the forming mold.

[FIG. 8] is a schematic sectional view illustrating the forming mold when a counter-pressure air is injected.

[FIG. 9] is a sectional view illustrating a use state of the seal material by enlarging a portion “A” in FIG. 8.

[FIG. 10] is a schematic sectional view of the forming mold after the core-back operation.

[FIG. 11] is an attachment view illustrating a use state of the seal material having an interconnected cell structure after the core-back operation by enlarging a portion “B” in FIG. 10.

[FIG. 12] is an attachment view illustrating the enlarged portion “A” in FIG. 8 in which a seal material having a rectangular shape in traverse section is used.

[FIG. 13] is an attachment view illustrating the enlarged portion “B” in FIG. 10 in which the seal material having a rectangular shape in traverse section is used.

[FIG. 14] is a sectional view after the core-back operation corresponding to the portion “B” in FIG. 10 illustrating a conventional O-ring made of urethane rubber (solid) corresponding to FIG. 11.

[FIG. 15] is a sectional view after the core-back operation corresponding to the portion “B” in FIG. 10 illustrating a conventional O-ring made of urethane rubber (solid) and having a bullet-like shape in section corresponding to FIG. 11.

### DESCRIPTION FOR EMBODYING THE INVENTION

In the following, an embodiment of the present invention will be described with reference to the accompanying drawings.

The present invention is a technique for preventing occurrence of a swirl mark or a depression (a crater) on a foam-molded product or article that is a defect in appearance peculiar to foam molding in the injection foam molding using a forming mold.

FIG. 1 is a schematic sectional view illustrating the embodiment of the forming mold according to the present invention. A forming mold 10 is provided for an injection molding machine, not shown, and includes a pair of a fixed mold (mold half) 11 and a movable mold (mold half) 12.

As shown in FIGS. 1 and 2, a supply path (sprue groove) 14 that guides the molten resin supplied from a resin supply side, and an air supply/discharge hole 15 to supply and discharge air are formed in the fixed mold 11. The movable mold 12 is fitted to the fixed mold 11 so as to be engaged retractably. A cavity 16 as a molding space is formed in a concave-convex fitting portion between the fixed mold 11 and the movable mold 12. To be more specific, the cavity 16 is formed between a concave portion of the fixed mold 11 and a convex portion of the movable mold 12. The molten resin is supplied into the cavity 16 through the supply path (sprue groove) 14. A concave-convex relationship between the concave portion of the fixed mold 11 and the convex portion of the movable mold 12 may be reversed.

The air supply/discharge hole 15 of the fixed mold 11 is joined to an external pipe, not shown, so as to be connected to an air supply source and a discharge facility, both not shown, in a switchable manner via a valve or the like. The pressurized air used in a counter-pressure method or the like can be supplied or discharged.

An elastically-deformable seal material 18 is also provided in a closed loop shape on a mating surface between the fixed mold 11 and the movable mold 12 so as to surround the cavity 16. The seal material 18 is formed of an elastic foam (i.e., elastic foam material) having interconnected cells such as an urethane foam. Examples of the elastic foam include natural rubber (NR), chloroprene rubber (CR), ethylene-propylene rubber (EPN), ethylene-propylene-diene rubber (EPDM), nitrile rubber (NBR), and silicon rubber (SiR) in addition to the urethane foam.

The seal material 18 as the elastic foam having interconnected cells is composed of a rubber elastic body having a sealing function with the interconnected cells collapsing when pressurized, and when the pressure is released, the interconnected cell structure is restored by an elastic restoring force.

The seal material 18 is fixed to the mating surface of the fixed mold 11 or the movable mold 12 with an adhesive tape 19 as shown in FIG. 3. Thus, it is not always necessary to provide a groove for attaching a seal material in the fixed mold 11 or the movable mold 12. The seal material 18 is formed in a rectangular shape in section having a sectional area of 1×m, e.g., 10 mm×30 mm.

In the case of using the closed-loop elastic foam having the interconnected cells as the seal material 18, when the forming mold 10 is closed, the interconnected cells of the seal material 18 collapse to fulfill the sealing function. Accordingly, in the injection foam molding in the forming mold 10 using the counter-pressure method, a pressure high enough to prevent foaming or defoaming can be applied to the molten resin injected into the cavity 16 of the mold by injecting the pressurized air.

In addition, when the forming mold 10 is opened, the interconnected cell structure of the seal material 18 is restored due to a property of the interconnecting cells (elastic restoring force) having rubber elasticity in a core-back operation in which the movable mold 12 is retracted from the fixed mold 11. Thus, when the mold 10 is opened in the core-back operation, compressed air remaining in a flowing terminal end of the molten resin can be discharged outside of the mold 10. Therefore, inhibition of the foaming of the molten resin by the residual air can be prevented.

As mentioned above, when the molten resin made of a resin material is subjected to the injection foam molding by the counter-pressure method by using the forming mold 10 shown in FIGS. 1 and 2, a foam-molded product 20 can be obtained as shown in FIG. 4.

### [Foamed Resin Molding Using Forming Mold]

When the injection foam molding is performed to obtain the foam-molded product by using the forming mold 10, a mixture obtained by adding a chemical foaming agent of sodium hydrogen carbonate (NaHCO3) to polypropylene (PP) resin is prepared as the resin material.

In the mold-clamped state of the forming mold 10 in which the fixed mold 11 and the movable mold 12 are closed as shown in FIG. 1, when the pressurized air is injected into the cavity 16 of the mold through the air supply/discharge hole 15 from the air supply source, in the counter-pressure method, a pressure in the inner portion of the mold 10 is increased to a prescribed pressure, e.g., about 0.4 MPa. The pressure in the inner portion of the mold 10 is preferably increased to a pressure high enough to suppress the foaming of the molten resin, e.g., 0.3 MPa to less than 1 MPa.

When the pressurized air is supplied from the air supply source into the forming mold 10 in the mold-clamped state shown in FIG. 1, the interconnected cells of the seal material 18 collapse to fulfill the sealing function. Accordingly, when the pressurized air is injected into the mold 10, the pressure inside the mold 10 is increased.

When the pressure inside the forming mold 10 reaches the prescribed pressure, the molten resin WR to which the foaming agent is added is injected from the supply path 14 to fill the cavity 16 (see FIG. 5). After feeding the molten resin WR, the air injection is stopped by an air switch valve, not shown, to obtain a natural discharge state. Since the pressure inside the mold is higher than a foaming pressure before the core-back operation, the foaming is suppressed even when the molten resin WR is fed therein.

The movable mold 12 is retracted from the fixed mold 11 in the core-back operation. When the core back operation is started, however, the sealing function of the seal material 18 is retained to some extent. Thus, it is difficult to discharge the compressed air in the flow terminal end of the molten resin WR outside of the mold 10, and hence, the foaming of the molten resin is suppressed by the air.

When the core-back operation proceeds and the mold 10 is opened, the interconnected cell structure of the seal material 18 is restored by the elastic restoring force. The residual air in the flow terminal end can be thereby discharged outside of the mold 10 through the interconnected cells. Accordingly, the inhibition of the foaming of the molten resin WR by the residual air can be prevented.

The forming mold 10 is set to, for example, a product thickness (i.e., thickness of the cavity 16) of 3 mm in the mold-clamped state in which the fixed mold 11 and the movable mold 12 are closed, and a core-back amount of 2 mm so as to hold the foam-molded product 20 having a thickness of 5 mm. The foam-molded product 20 has a dimensional shape with a rectangular surface of Pxq, e.g., 150 mm×50 mm.

A specification example of the injection molding machine, not shown, including the forming mold 10 according to the present embodiment is shown in Table 1.

TABLE 1
Specification of Injection Molding Machine

| | |
|---|---|
| Maximum Injection | 216 MPa |
| Maximum Injection Speed | 160 mm/sec |
| Maximum Injection Stroke | 180 mm |
| Mold Clamping Force | 180 tf |

In the forming mold 10 according to the present embodiment, the air supply/discharge hole 15 is set to the natural discharge state in the core-back operation in which the movable mold 12 is retracted from the fixed mold 11 after injecting the pressurized air. The interconnected cells of the seal material 18 are restored with the interconnected cells recovering from the collapsed state due to the property of the elastic foam (material), having the elastic restoring force. When the core-back operation proceeds, the residual air in the cavity 16 of the mold is discharged outside of the mold through the interconnected cells. The molten resin WR is foamed in the cavity 16, so that the foam-molded product 20 is formed as shown in FIG. 5. In FIG. 5, reference numeral 22 denotes a sprue, and reference numeral 23 denotes a runner.

The foam-molded article 20 shown in FIG. 6 is obtained by the core-back operation of the forming mold 10. The foam-molded product 20 obtained by the core-back operation of the forming mold 10 is removed from the mold 10 by largely retracting the movable mold 12 as shown in FIG. 7.

An example of the main molding conditions of the forming mold 10 in the present embodiment is shown in Table 2.

TABLE 2
Molding Condition of Forming Mold

| | |
|---|---|
| Molten Resin Injection | 0.5 sec |
| Core-back Delay Time | 0.5 sec |
| Core-back Amount | 2 mm |
| Core-back Transition Time | 0.1 sec |

A core-back delay time in Table 2 means a time from the completion of the injection of the molten resin into the cavity 16 of the mold to start of the core-back operation. The core-back delay time is set so as to start the core-back operation after forming a skin layer on the molten resin surface.

### EXAMPLE

The injection foam molding can be performed by mounting the forming mold 10 to the injection molding machine, not shown. When the forming mold 10 is closed into the mold-clamped state between the fixed mold 11 and the movable mold 12 as shown in FIG. 8, the interconnected cells of the closed-loop seal material 18 collapse as shown in FIG. 9 to thereby assume a sealing structure. When the air is supplied from the air supply/discharge hole 15, a pressure highly enough to prevent the defoaming of the molten resin can be applied even when the molten resin is injected into the cavity 16 of the mold to fill the cavity 16.

When the forming mold 10 is opened as shown in FIG. 10 by the core-back operation, the rubber-elastic seal material (the elastic foam) 18 having the interconnected cells allows the residual air to be discharged outside of the mold of the forming mold 10 due to the property of the interconnected cells having the elastic restoring force.

Accordingly, since the residual air within the mold 10 that prevents the foaming can be efficiently discharged outside of the mold 10 through the interconnected cells of the seal material 18, the occurrence of the swirl mark and the depression (crater), as the appearance defect peculiar to the foam molding, can be prevented.

As described above, in the forming mold 10 in which the seal material 18 as the elastic foam having the interconnected cells is used, the interconnected cells of the seal material 18 are restored by the elastic restoring force in the core-back operation in which the movable mold 12 is retracted from the fixed mold 11. The sealability is thereby lowered to release the air outside of the mold 10. The air is easily discharged outside of the mold. Therefore, the air can be effectively prevented from remaining in the foam-molded product 20 and the occurrence of the depression can be suppressed.

When the foam-molded product has a simple product shape, it is not necessary to discharge the air remaining in the forming mold by vacuum drawing operation. It is thus not necessary to introduce a vacuuming equipment or like.

Furthermore, the seal material 18 as the elastic foam in the closed loop and having the interconnected cells may have a circular shape in section, a rectangular shape in section as shown in FIGS. 12 and 13, or an elliptical or oval shape, and various shapes may be employed.

Next, the following Table 3 shows a results of comparison of appearance of form-molded products molded by the injection foam molding by using the counter-pressure method, which was performed by preparing:

(1) an elastic foam (an urethane foam) having interconnected cells;

(2) an O-ring made of urethane rubber (solid) according to a conventional technique; and

(3) no O-ring as the seal material of the forming mold.

TABLE 3
Appearance Comparison Result of Foam-molded Product

| | Seal Material | Counter- | Swirl | Depression |
|---|---|---|---|---|
| 1 | Urethane Foam | 0.4 MPa | ∘ | ∘ |
| | Product of | | | |
| 2 | Urethane Rubber | 0.4 MPa | ∘ | x |
| 3 | No O-ring | 0.25 MPa | x | x |

∘: No Occurrence
x: Occurrence

As can be seen from the Table 3, when the urethane foam (elastic foam material) having the interconnected cells was used as the seal material 18, since a counter pressure highly enough to suppress the defoaming was obtained in the forming mold 10, the foam-molded product 20 with no swirl mark or depression was obtained. In the case of no O-ring, the counter pressure for suppressing the defoaming was not obtained, and the appearance defect such as the swirl mark and the depression occurred in the foam-molded product.

In the meantime, when the foam molding was performed by sealing the forming mold with a conventionally-used solid O-ring 24 made of urethane rubber as shown in FIG. 14, the required counter pressure was obtained, so that the swirl mark was suppressed. However, it was considered that the depression was caused by catching the counter-pressure residual air occurred in the flow terminal end, and a foaming defect occurred due to insufficient foaming of the foam-molded article.

It is further considered that the foaming defect in the flow terminal occurred because of the existence of air not discharged outside of the forming mold in a compressed state in the flow terminal end, thus the foaming being inhibited when a pressure was released by the core-back operation.

Problems similar to those in FIG. 12 also occurred when a solid O-ring 25 made of urethane rubber (solid) and having a bullet-like shape in section as shown in FIG. 15 was used. When the O-rings 24 and 25 made of urethane rubber (solid) are used, it is necessary to form a ring groove 26 in which the solid O-ring in the mating surface of the mold is accommodated.

Although the example of the present embodiment, in which the air supply/discharge hole 15 and the seal material 18 are provided on the fixed mold 11, is described, the air supply/discharge hole and the seal material may be also provided on the movable mold side.

### REFERENCE NUMERAL

10 - - - forming mold

11 - - - fixed mold

12 - - - movable mold

14 - - - supply path (sprue groove)

15 - - - air supply/discharge hole

16 - - - cavity (molding space)

18 - - - sealing material

19 - - - adhesive tape

20 - - - foaming molded product

22 - - - sprue

23 - - - runner

1. A forming mold configured to manufacture a foam-molded product, by molding, in use of a counter-pressure method, the foal-molded product that is obtained by feeding molten resin into a cavity formed within a fixed mold and a movable mold mated together,
wherein a seal material that seals pressurized air used in the counter-pressure method between the fixed mold and the movable mold is composed of an elastic foam material having interconnected cells.

2. The forming mold of claim 1, wherein the seal material is provided on a mating surface of at least one of the fixed mold and the movable mold in a manner of a closed loop surrounding the cavity.

3. The forming mold of claim 1, wherein the interconnected cells of the seal material are restored by an elastic restoring force in a core-back operation in which the movable mold is retracted from the fixed mold.

4. A method for molding a foam-molded product obtained by feeding molten resin into a cavity formed within a fixed mold and a movable mold mated together, the method comprising:
forming a cavity to be filled with molten resin in a forming mold with a fixed mold and a movable mold;
sealing the cavity with interconnected cells of a seal material collapsed when the forming mold is closed;
discharging residual air that prevents foaming of the molten resin outside of the forming mold due to a property of the interconnected cells of the seal material having an elastic restoring force when the forming mold is opened; and
producing a foam-molded product from the molten resin in the forming mold.
